(19) United States
(12) Patent Application Publication
(10) Pub. No.: US 2026/0100073 A1
(43) Pub. Date: Apr. 9, 2026

(54) SYSTEMS AND METHODS OF USING A PASSIVE DEVICE FOR VEHICLE INFORMATION TRACKING

(71) Applicant: T-MOBILE INNOVATIONS LLC, Overland Park, KS (US)

(72) Inventors: Maricris BORILLO, Bothell, WA (US); Gaviphat LEKUTAI, Kirkland, WA (US); Pei HOU, Centreville, VA (US)

(21) Appl. No.: 18/908,417

(22) Filed: Oct. 7, 2024

(51) Int. Cl. G07C 5/00

(52) U.S. Cl. CPC G07C 5/008

(57) ABSTRACT

Systems and methods are provided for using devices to power e up and/or read a tag, which may be affixed to a vehicle. The tag may be an ambient IoT device and/or an RFID device, for example, that contains vehicle information, such as mileage or maintenance-related information. An application with an interface may be used for locating or requesting information about the vehicle. In some cases, the registration status of a vehicle can be obtained by or submitted to an authority, or other vehicle-related information can be viewed by a vehicle owner or manager via the application.

### SUMMARY

A high-level overview of various aspects of the invention are provided here, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to systems and methods for using a passive tag in association with a vehicle and a mobile device, substantially as shown in and/or described in connection with at least one of the figures, and as set forth more completely in the claims.

In aspects set forth herein, and at a high level, the systems and methods comprise using a mobile device to power up a passive tag associated with a vehicle and collect data from the tag, in embodiments, in order to identify, locate, or obtain vehicle information. In some cases, an interface enables a user to locate or read information about a vehicle or vehicles. In embodiments, systems and methods are provided for registering or tracking vehicle(s) by an entity such as a governmental agency or a company.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an exemplary environment in accordance with embodiments described herein;

FIG. 2 depicts an exemplary environment in accordance with embodiments described herein;

FIG. 3 depicts an interface relating to information about a vehicle, in accordance with aspects herein;

FIG. 4 depicts an interface relating to information about one or more vehicles, in accordance with aspects herein;

FIG. 5 depicts a diagram of one or more vehicles, in accordance with aspects herein;

FIG. 6 depicts a flow diagram illustrating aspects of systems and methods in accordance with embodiments described herein;

FIG. 7 depicts a flow diagram illustrating aspects of systems and methods in accordance with embodiments described herein; and

FIG. 8 depicts an exemplary computing environment suitable for use in implementations of the present disclosure, in accordance with aspects herein.

### DETAILED DESCRIPTION

Traditionally, it can be difficult to track equipment such as vehicles. For instance, tracking vehicles could require bulky equipment powered by batteries that can transmit signal, which users may notice. Users of equipment, such as employees or renters of vehicles, may prefer to remove any tracking-related technology because of its power demands or for other reasons, for example for privacy. In conventional technologies, aspects of equipment-tracking technology (such as a tag) would not be automatically powered and/or communicated with by a device, and information would not be shared, for example with a vehicle owner, because a driver would interfere with the equipment or opt not to activate or use the equipment.

In aspects provided herein, a passive tag on a vehicle, which is used for tracking or sharing other vehicle information, is powered up through radio waves transmitted, in some cases automatically, by a device, such as a cellular phone. The passive tag does not transmit signal actively, in embodiments, therefore it has very low power consumption. When a mobile device transmits a radio signal to the passive tag, the signal is back-scattered by the passive tag back to the mobile device. The back-scattered signal is used to carry the vehicle information stored in the passive tag, which can be received at the mobile device and communicated for use at an interface on another mobile device (such as a map of vehicles). In some cases, a passive tag is remotely accesses and vehicle information can be viewed and/or verified (e.g., by time or location) based on the mobile device, which can also power the passive tag.

In exemplary embodiments, systems are provided for identifying, locating, and/or obtaining information regarding vehicle(s), at least in part based on a network associated with devices that activate passive tags corresponding to the vehicle(s). In some embodiments, an interface is provided for a driver or owner via an application, in order to locate or read information about a vehicle. An interface may also be provided for a manager or owner of vehicle(s) to locate or read information about the vehicle(s). In some cases, systems are provided for registering or tracking vehicle(s) by an entity such as a governmental entity or a private company, as discussed in more detail below.

In a first aspect, a system is provided that allows for viewing of vehicle information, for example by providing an application to a user device. The application, in embodiments, receives information from a mobile device in e a vehicle, which is analyzed to determine the location of the vehicle. In some cases, the passive device back-scatters a signal from the mobile device and uses it to send the information from the passive device to the user device. In another aspect, embodiments are directed to receiving, at an interface of a first mobile device, a request for data related to a vehicle, and issuing another request to a second mobile device, which causes the second mobile device to activate and read a tag affixed to the vehicle.

In a second aspect, a tag stores the data related to the vehicle, which can be received from the second mobile device at an application associated with the interface of the first mobile device. The data related to the vehicle can be displayed at the interface of the first mobile device. In some cases, the data can be an indication of an expiration status, or a license plate number. In a third aspect, for example, a geographic area of the vehicle is determined based on the second mobile device, and this area or a location can be shown at an interface of the first mobile device.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
ATIS Automatic Terminal Information Service Procedures
CAN Controller Area Network
CD-ROM Compact Disk Read Only Memory
CDMA Code Division Multiple Access
DL/UL AoA Downlink/Uplink Angle of Arrival
DL/UL TDoA Downlink/Uplink Time Difference of Arrival
DMV Department of Motor Vehicles
DOT Department of Transportation
ECU Electronic Control Unit
ETSI European Telecommunications Standards Institute
eNB Evolved Node B
gNB Next Generation Node B
GPRS General Packet Radio Service
GSM Global System for Mobile communications
DVD Digital Versatile Discs
EEPROM Electrically Erasable Programmable Read Only Memory
EMS Enhanced Message Service
FD-MIMO Full-Dimension Multiple-Input Multiple-Output
IMS IP Multimedia Subsystem
IMSI International Mobile Subscriber Identifier
IoT Internet-of-Things
LMF Location Management Function
LTE Long Term Evolution
MIMO Multiple-Input Multiple-Output
MMS Multi-media Message Service
MU-MIMO Multi-User Multiple-Input Multiple-Output
Multi-RTT Multi-Cell Round Trip Time
OBD On-Board Diagnostics
PC Personal Computer
PDA Personal Digital Assistant
RAM Random Access Memory
RF Radio-Frequency
RFID Radio Frequency Identification
ROM Read Only Memory
RRU Remote Radio Unit
TDMA Time Division Multiple Access

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

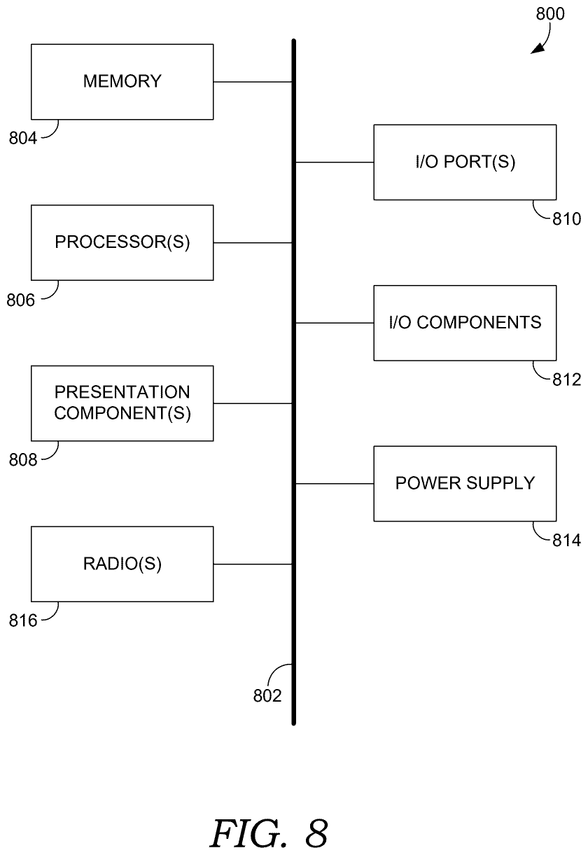

Additionally, a “user device,” as used herein, is a device that has the capability of using a wireless communications network, and may also be referred to as a “computing device,” “mobile device,” “wireless communication device,” or “user equipment” (“UE”). A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A UE may be, in an embodiment, computing device 800, described herein with respect to FIG. 8, below.

A computing device may additionally include Internet-of-Things (IoT) devices, such as one or more of the following: a sensor, controller (e.g., a lighting controller, a thermostat), appliances (e.g., a smart refrigerator, a smart air conditioner, a smart alarm system), other Internet-of-Things devices, or combinations thereof. Internet-of-Things devices may be stationary, mobile, or both. In some aspects, a computing device is associated with a vehicle (e.g., a video system in a car capable of receiving media content stored by a media device in a house when coupled to the media device via a local area network). In some aspects, a computing device comprises a medical device, a location monitor, a clock, other wireless communication devices, or combinations thereof.

Further, the term “telecommunications network service” provided by the IMS layer, as used herein, includes wireless communications via the transfer of information via one or more of the following: radio waves (e.g., Bluetooth®), satellite communication, infrared communication, microwave communication, Wi-Fi, and mobile communication. Telecommunications network services may be provided via one or more wireless telecommunication technologies or standards, including, but not limited to, CDMA 1×Advanced, GPRS, Ev-DO, TDMA, GSM, WiMax technology, LTE, LTE Advanced, 4G, 5G, 6G, or other generation communication systems, among other technologies and standards. The telecommunications network services may be provided via a network (e.g., the transfer of information without the use of an electrical conductor as the transferring medium).

In aspects, the network may be a telecommunications network(s), or a portion thereof. A telecommunications network might include an array of devices or components (e.g., one or more cell sites). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a telecommunications network can connect one or more subscribers to a corresponding immediate service provider for services such as 5G and LTE, for example. In aspects, a network provides voice, message (e.g., SMS messages, MMS messages, instant messaging messages, EMS messages), or data services to user devices or corresponding users that are registered or subscribed to utilize the services provided by a telecommunications provider. The network can comprise any communication network providing voice, message, or data service(s), such as, for example, a 1×circuit voice, a 3G network (e.g., CDMA, CDMA2000, WCDMA, GSM, UMTS), a 4G network (WiMAX, LTE, HSDPA), a 5G network, a 6G network, and any combination thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay cell sites, LMFs, or other network components. The network may interface with cell sites or access points through one or more wired or wireless backhauls. As such, the cell site and access point may communicate via the network or directly. Furthermore, user devices can utilize the network to communicate with other devices (e.g., a mobile device(s), a server(s), a personal computer(s), etc.) through the cell site or access point.

As used herein, the term “cell site” (used for providing UEs with access to the telecommunications network services) generally refers to one or more cellular base stations, nodes, RRUs control components, and the like (configured to provide a wireless interface between a wired network and a wirelessly connected user device). A cell site may comprise one or more nodes (e.g., eNB, gNB, and the like) that are configured to communicate with user devices. In some aspects, the cell site may include one or more band pass filters, radios, antenna arrays, power amplifiers, transmitters/receivers, digital signal processors, control electronics, GPS equipment, and the like. An eNB or gNB corresponding to the cell site may comprise one or more of a macro base station, a small cell or femto base station, a relay, and so forth. In aspects, the cell site may be configured as FD-MIMO, massive MIMO, MU-MIMO, cooperative MIMO, 3G, 4G, 5G, another generation communication system, or 802.11. In addition, the cell site may operate in an extremely high frequency region of the spectrum (e.g., from 30 GHz to 300 GHz), also known as the millimeter band.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

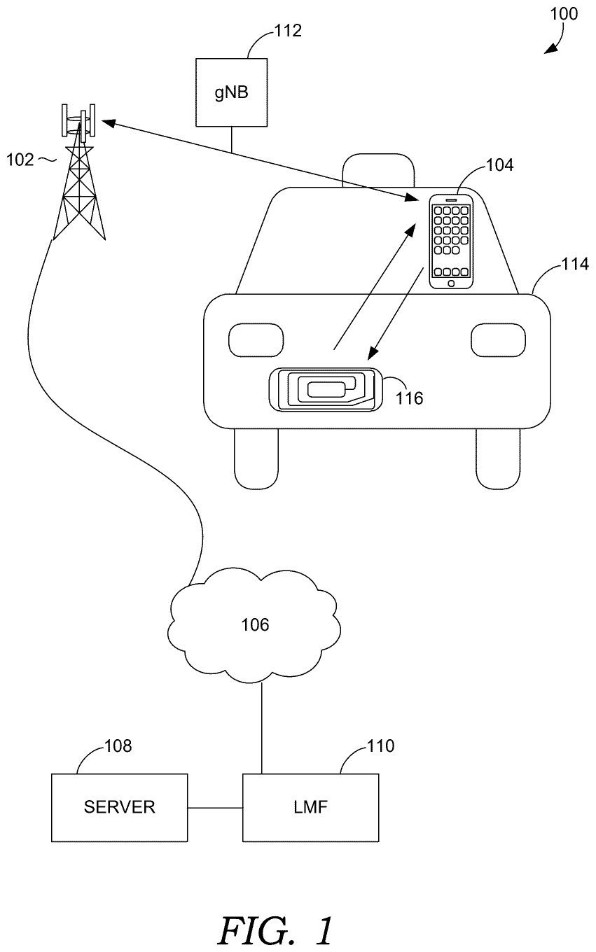

Turning now to FIG. 1, an exemplary environment 100 for implementing embodiments directed to obtaining vehicle information is shown. In FIG. 1, exemplary environment 100 includes cell site 102 in communication with UE 104. Cell site 102 is also in communication with network 106. In one example, network 106 is connected to server 108 and Location Management Function (LMF) 110, as illustrated in FIG. 1. In some cases, server 108 is directly connected to network 106. LMF 110 may be housed on or hosted by server 108, or included as or part of server 108. Server 108 is a central server, or it is distributed among multiple server devices in some embodiments. In one example, LMF 110 reports location(s) of UE(s) and/or associated vehicles to a server (e.g., server 108).

As shown in FIG. 1, gNB 112 is a node in a network, which may provide connectivity between UEs (e.g., UE 104) and a network (e.g., network 106), for example connectivity to a network core or backbone. gNB 112 provides 5G network services to devices such as UE 104, or other types of networks can be used to implement embodiments described herein. Aspects of network 106, such as LMF 110 or server 108, are used to determine a location or geographic area of UE 104, which is in the proximity of vehicle 114. As one example, a network (e.g., network 106) uses one or more methods to determine a location of UE 104. Potential methods include Cell ID positioning or Enhanced Cell ID positioning.

In some cases, Cell ID positioning can be performed by paging or tracking area updates to determine information about a serving node and/or cell. Enhanced Cell ID positioning can include one or more aspects of Cell ID positioning and may, optionally, also include one or more additional measurements that improve the positioning of a UE such as UE 104, such as other UE-related or other radio-related measurements, in some cases. Other potential methods to determine a location of a device such as UE 104 include Multi-Cell Round Trip Time (Multi-RTT) positioning, for instance. Other methods are Downlink/Uplink Time Difference of Arrival (DL/UL TDoA) and/or Downlink/Uplink Angle of Arrival (DL/UL AoA). In these examples, aspects of network 106 determine a geographic range or path of UE 104 in order to locate or track vehicle 114 (or multiple UEs and vehicles, in some cases).

Continuing with FIG. 1, vehicle 114 is shown in proximity to UE 104. A person or group of people traveling in vehicle 114 possess UE 104, in one example, or an autonomous vehicle 114 is equipped with UE 104, which may be mounted on a dashboard or otherwise secured as part of vehicle 114. In other examples, vehicle 114 includes one or more components that comprise UE 104, such as an onboard system with communication and/or navigation capabilities. In embodiments, a driver of vehicle 114 carries or uses UE 104, and the driver owns vehicle 114 or is employed by an owner of vehicle 114. In other embodiments, a passenger of vehicle 114 has UE 104, or an inspector or other individual has UE 104, in proximity to vehicle 114 at some point in time, as shown in the example in FIG. 1. As discussed below, UE 104 can activate a passive component or communicate with a passive device.

FIG. 1 illustrates an example of tag 116. Tag 116 is a sticker or other passive component that does not include a battery, in embodiments. Tag 116 is activated or powered up by another mobile device UE 104, for example. Tag 116 can be an IoT device. In some cases, tag 116 is a device that meets the description or functionality of a “Device A” according to the 3GPP standard, Release 18 (TR 38.848) In certain embodiments, tag 116 is a passive or IoT device in accordance with standards or systems such as Automatic Terminal Information Service Procedures (ATIS), 3GPP, NA3 and/or European Telecommunications Standards Institute (ETSI) 3GPP.

Tag 116 is a lower-cost and/or lower-maintenance (or maintenance-free) component with very low power consumption than other options for storing or providing information because it is battery-less and does not contain a transmitter. One or more of these bases also makes tag 116 a more attractive or less intrusive approach for locating vehicle(s) or obtaining information about vehicle(s), which consumers or employees may notice less or be less hesitant about including on a vehicle.

In certain embodiments, tag 116 is an ambient IoT device, capable of harvesting energy from waves such as radio waves, motion, or heat. Consistent with potential benefits discussed above, an ambient IoT device can be relatively small and/or cheap compared to other devices, even other IoT devices. Tag 116 can send data, for instance packet(s) of data, without a battery or separate power connection beyond power provided by another device, such as a device that reads or activates tag 116. In embodiments, UE 104 powers up tag 116, for example using radio waves or radio frequency (RF) waves. The transmitted signal is back-scattered back to the UE 104 and the back-scattered signal is used to send the information stored in the tag 116, for example as shown in FIG. 1 with tag 116 in communication with UE 104.

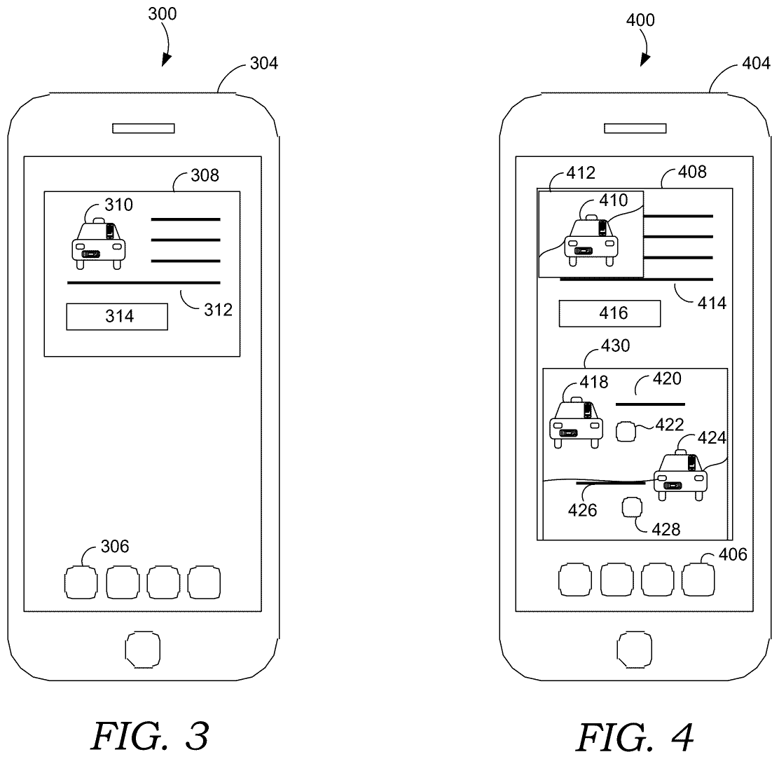

In embodiments, a passive device such as tag 116 stores vehicle information (e.g., vehicle information 312 discussed with respect to FIG. 3, below) and sends it to UE 104 in the form of a modulated signal after harvesting enough power from the radio waves transmitted UE 104. The radio signal can be WiFi, Bluetooth, or Bluetooth Low Energy in any other available frequency bands, for example, depending on availability or other factors. The vehicle information contained on tag 116 is sent back to UE 104 through back-scattered signal, in embodiments. An application on UE 104 or another device requests only part of the data available from tag 116, in some cases, such as identification information to verify vehicle 114 or confirmation of valid registration or license information associated with vehicle 114.

Conventional systems for locating or polling information from vehicles in computerized systems suffer from users wanting to remove or disable devices that are noticeable, draw power, and/or include a power source for communicating with other devices. Therefore, such systems can be rendered ineffective due to power issues over time, for example, or removed by a user. In addition, conventional systems may wait to transmit information or be disabled or limited, for example due to power demands or availability at a vehicle (e.g., vehicle 514), and remotely obtaining current information about the vehicle may be impossible. Furthermore, conventional systems are not able to reliably or automatically provide information if subject to users providing power or allowing a device to draw or require power.

Embodiments of the solutions described herein address issues relating to tracking equipment, such as vehicles, even when users of vehicles do not want a powered device (or a device with a power source or demand) affixed to their vehicles. For example, embodiments allow for auto-powering and auto-reading of equipment information, and automatically providing such information, for access via an interface (e.g., interface 400, discussed below) at a remote device. Exemplary solutions include specific steps of providing energy harvesting source and transmitting radio signal, by a mobile device for use with a passive tag placed on equipment, and receiving information about the vehicle at the mobile device that is communicated over a network to be provided at an interface on another mobile device. The use of back-scattered signal from a passive vehicle tag, implemented by a mobile device in order to communicate vehicle information to a remote device, in specific embodiments described herein, provides a solution to issues that arise with attempts to track or monitor vehicles. The embodiments disclosed provide solutions for remotely accessing and viewing vehicle information that can be verified by time or location using a mobile device, which can also power a passive tag.

In another example, tag 116 can be a Radio Frequency Identification (RFID) tag that is used with a device (e.g., UE 104) where the device acts as an RFID reader. A reader transmits signals such as radio waves to activate an RFID tag and the RFID tag responds with waves sent to an antenna at the reader, in some cases. In this example, data stored in the tag 116 is sent back to the reader through the reflected radio signal . . . UE 104 can activate tag 116 and communicate to, or write to, tag 116, for example providing information about UE 104 or a location or other data to tag 116 to be stored by tag 116.

In embodiments, tag 116 contains information from or about vehicle 116, output by one or more computing systems and/or sensor(s) of vehicle 116. Information may be output from vehicle 114 or written to tag 116 by software used by vehicle 114. For example, an on-board diagnostics (OBD) system or other system or network of sensors can output data to tag 116. In embodiments, an Electronic Control Unit (ECU) or other aspect of a system monitors or records data about vehicle 116, such as mileage or trip data. As other examples, data such as a current trip distance, miles traveled since a point in time or location or since association with a particular UE (e.g., UE 104), maintenance updates or needs, time since last movement or contact with UE 104, or route/safety information is provided to and recorded by tag 116 with respect to vehicle 114. Any combination of such data can be collected and recorded for access by an application on UE 104 or another application. As one example, an application receives a route and aspects of network 106 and/or the application determine whether vehicle 114 has adhered to the route or followed traffic safety recommendations, based on travel or other information provided to tag 116 as output by vehicle 114.

An ECU data log or other record is used to send data to tag 116, in some cases, and/or real-time data can be collected and pushed to tag 116. The current or most-recent information about vehicle 114 is collected and written to tag 116 when tag 116 is activated by a device such as UE 104, in some cases. In other cases, information about vehicle 114 is regularly or periodically pushed to tag 116 by vehicle 114, for instance at a time when vehicle 114 is powered on and/or has Bluetooth access or another method for powering a passive device such as tag 116. In one example, when an application on UE 104 (e.g. application 408, discussed below) communicates with tag 116 or vehicle 114, this instructs or causes vehicle information (e.g., vehicle information 414, discussed below) to be provided or written to tag 116. A user of UE 104 or another UE with an application can trigger collection of vehicle information to be recorded to tag 116 in some cases.

Tag 116 can be encrypted, so that only authorized vehicles and/or UEs, such as vehicle 114 and/or UE 104 (using an application, for example) can access the data written to tag 116. An application may require a user to enter credentials before providing vehicle information (e.g., vehicle information 414) from tag 116 to UE 104 or to any other device via network 106. An application may provide information from tag 116 in an encrypted format that can only be decrypted by authorized applications or devices. In one embodiment, a government entity or company such as a rental car company must provide authentication information associated with vehicle 114, UE 104, or an application in order to receive vehicle information at an application. For example, a car rental company may be required to register each vehicle it intends to track or request information about, so that an application used by the company is authorized to receive information about each vehicle via an application such as application 408 in FIG. 4, discussed below.

In the exemplary environment 100 in FIG. 1, tag 116 is associated with vehicle 114. Tag 116 can be affixed to vehicle 114 or placed within or on vehicle 114, or tag 116 can be integrated with vehicle 114, for example during manufacturing and/or as an integral part of vehicle 114 to avoid transfer of tag 116 to another vehicle. In other embodiments, tag 116 can be removed and placed on various vehicles with a procedure for associating tag 116 with a new vehicle (for example by associating tag 116 with a new vehicle identification number, etc.). Tag 116 can include circuitry in direct or indirect communication with vehicle output component(s) or vehicle circuitry for purposes of receiving vehicle information. For example, part of tag 116 can be inserted into or operable with an OBD port (e.g., an OBD2 port) or a Controller Area Network (CAN) bus network in vehicle 114. Accessing a CAN bus network of vehicle 114 can provide tag 116 with information from one or more ECUs in vehicle 114, such as ECUs dedicated to body control, engine control, speed, etc. In some cases, vehicle 114 is able to power tag 116 using an on-board system and write vehicle information to tag 116, which may be encrypted information from any of the potential outputs described above. For example, an application may exist on a computing system of vehicle 114 that is authenticated or verified and able to write to tag 116. In one specific example, the application on vehicle 114 activates tag 116 and writes information when a maintenance issue or route derivation occurs, so that a notification can be provided (e.g., notification 416 in FIG. 4).

In some cases, tag 116 receives vehicle information by being programmed or manually set to correspond to a vehicle, for example an authority or company can link a particular vehicle (e.g., by identification number or license number) with tag 116 in the memory of tag 116 or in a database accessible via network 106. In embodiments, server 108 stores relationship information that connects specific tags (e.g., tag 116) with specific vehicles (e.g., vehicle 114). Tag 116 can record if it is associated with a new or second vehicle (or UE) and provide this information for use by a system.

An application (e.g., application 308, discussed below with respect to FIG. 3) can wake up tag 116 due to a selection by a user of UE 104 or by being in proximity to vehicle 114. An application is able to associate a geographic area with vehicle 114 using network 106, and this location information regarding vehicle 114 can be transmitted using network 106. In some cases, an application automatically causes UE 104 to provide power to tag 116 when UE 104 is within a range or distance from tag 116. In other cases, an application provides an interface (e.g., interface 300 in FIG. 3) for a user of UE 104 or another entity to submit a request to communicate with tag 116. In response, UE 104 can emit waves that will be used by tag 116 to enable tag 116 to communicate back to UE 104.

In some cases, an application provides information about UE 104 for determining location information, or network 106 can determine a location of UE 104 with or without an application in use, for example at LMF 110. A location may be a one-time data point regarding an approximate area of UE 104, or multiple locations may be tracked or determined over time and/or as UE 104 moves with vehicle 114. Network 106 can be used to determine spatial positions of various vehicles to be displayed by an application, as shown in the example in FIG. 4, discussed below. An application may display direction or acceleration information, or other movement information, about one or more vehicles via an interface. An application may combine this with vehicle information for relaying to an entity.

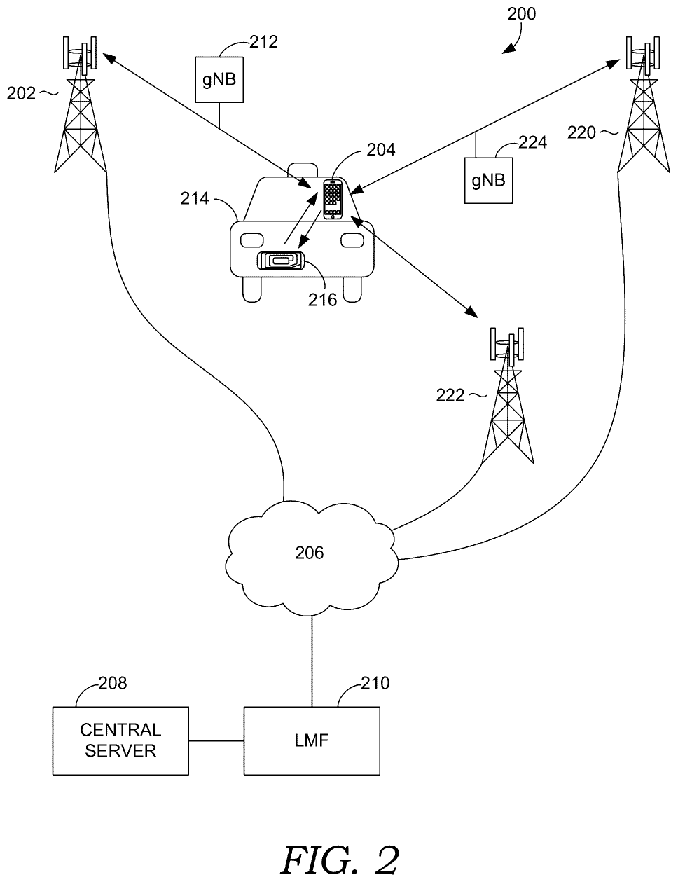

Turning to FIG. 2, an exemplary environment 200 is shown in accordance with embodiments described herein. In FIG. 2, cell site 202 is in communication with UE 204 and network 206, and network 206 is also in communication with central server 208 and LMF 210. Central server 208 and LMF 210 can be configured as one combined device or distributed across multiple devices. As shown in FIG. 2, gNB 212 can interface with UE 204 and provide information to network 206 via a connection provided by cell site 202. Vehicle 214 in FIG. 2 is associated with UE 204 and tag 216.

FIG. 2 illustrates one or more additional cell sites (e.g., cell sites 220, 222) potentially in communication with UE 204. Cell site 220 communicates with gNB 224. Cell site 222 may also interact with a gNB component or functionality (not shown). One or more cell site in FIG. 2 can be used to determine a location of UE 204 in one or more ways, for example using UL/DL AoA or another method. In some cases, two or more cell sites (e.g., cell sites 202, 220) are used in combination to determine a location of UE 204. In some cases, the location of UE 204 (and the corresponding location of vehicle 214) is more effectively or accurately determined using signals or data from more than one cell site, for example from two or three cell sites, although one can be sufficient.

In embodiments, LMF 210 determines a location of UE 204 (and thus an approximate location of tag 216 associated with vehicle 214) based on data from one or more cell sites. As another example, LFM 210 or another component of network 206 determines a location of vehicle 214 using information from one or more cell sites or base stations over time. For example, a signal from cell site 202 is initially used by LMF 210 or other network 206 components to determine a location of UE 204 at a first point in time, then a source such as cell site 220 is used to determine a location of UE 204 at another point in time. A server such as central server 208 associates both locations with vehicle 214 based on information verified or supplied by tag 216 to UE 204, in this example.

FIG. 3 illustrates an example of an interface, interface 300, of UE 304. UE 304 can be located in proximity to a vehicle that is represented on interface 300, for example UE 304 can belong to the driver or owner of such a vehicle. Interface 300 includes controls (e.g., control 306), in embodiments, and application window 308. Control 306 can be used to open and access application window 308 in order to display interface 300. An interface of an application in accordance with embodiments herein can display some or all of the vehicle information described herein. In one example, interface 300 has a control 306 that is used to activate an application and open application window 208, which then powers or triggers a tag on a vehicle represented by vehicle icon 310. A user is able to access and view vehicle icon 310 after UE 304 provides power to a passive device such as a tag that corresponds to the vehicle represented by vehicle icon 310.

In embodiments, a user of UE 304 views application window 308 and selects vehicle icon 310. This selection causes application window 308 to navigate to vehicle information 312, which was received by an application on UE 304 from a tag (e.g., tag 116) or a network device. Vehicle information 312 can be license or registration information, such as expiration data, or other vehicle data such as mileage or maintenance information. In embodiments, notification 314 is pushed to and/or automatically displayed by application window 308 when UE 304 powers a tag on a vehicle and where the tag has stored information that should be conveyed to a user. For example, a tag on a vehicle may have information about a maintenance need of a vehicle, such as being overdue for an oil change. An application window 308 can automatically display such a notification when UE 304 navigates to an application that causes powering of the passive tag or when a user selects a vehicle icon 310 or other button, for example.

An application used by UEs (e.g., UE 304) is capable of providing energy or power to passive devices such as IoT devices that comprise a tag (e.g., tag 116), and an application is capable of operating as a reader of a passive device when it transmits an RF signal, for example, and receives in return a back-scattered signal from the passive device. An application may also collect vehicle information (e.g., vehicle information 312) from a passive device such as tag 116, including license expiration information. In embodiments, an application reports vehicle information to a gNB (e.g., gNB 212 in FIG. 2). During the collection or reporting of vehicle information, it can be encrypted until an authorized request by an application or network component (e.g., LMF 210) to read the vehicle information. In embodiments, some or all of the vehicle information obtained from a tag and/or determined by network components (such as a location) is received by a server (e.g., central server 208).

In one use case, an owner of a vehicle 114 uses an application on a UE (e.g., UE 304) to view vehicle information 312 or notification 314 regarding vehicle 114 (which is represented on interface 300 as vehicle icon 310). The owner or driver may use this application to cause UE 304 to read a tag on vehicle 114 that verifies registration or license information via network 106 to an authority such as a DMV entity or employer. In another example, a driver or owner of a vehicle uses an application such as application 308 to verify a location of a vehicle using tag 116 for insurance or regulatory purposes, or for parking or toll-type recording. For instance, application 308 can display vehicle icon 310 on a map based on the determined location of a UE associated with the vehicle represented by vehicle icon 310.

Turning now to FIG. 4, an interface 400 is shown displayed by UE 404, for example after control 406 has been used to navigate to interface 400 of application 408. Interface 400 shows a first vehicle indicator 410, for example as located on a map 412 or other display. A user of application 408 could be a fleet manager for a car rental company or an owner or employer at a business, and this user may select vehicle indicator 410 in order to navigate interface 400 to a display of vehicle information 414, such as a driver of the vehicle represented by vehicle indicator 410, mileage of such a vehicle, route or route adherence of a vehicle, or other information. In some cases, notification 416 provides information about such a vehicle that is pushed to the user of application 408 or flagged for the user, to bring their attention to a maintenance issue, a delay or stall, a change in driver, or other information. In one embodiment, a UE associated with a vehicle (such as UE 104 associated with vehicle 114) communicates vehicle information 414 to application 408 for viewing by an employer or other user, and notification 416 indicates the UE has low battery power or another issue.

Continuing with interface 400 in FIG. 4, another vehicle indicator 418 is shown in association with vehicle information 420 for the vehicle indicated by vehicle indicator 418. Selectable icon 422 of interface 400 can be used to provide a user of UE 404 with additional vehicle information 420, such as a map with real-time movements based on a tag and UE associated with the vehicle indicated by vehicle indicator 418. In some cases, selectable icon 422 can be pressed on interface 400 of application 408 to call or send a message to the UE associated with the vehicle indicated by vehicle indicator 418. Thus, application 408 can be used by a user to contact a UE associated with a vehicle shown by vehicle indicator 418, by pressing selectable icon 422.

In another example, selectable icon 422 can be interacted with to trigger collection of vehicle information by a tag, such as tag 116. In other cases, application 408 can be used to select vehicle indicators (e.g., vehicle indicator 418) and set automatic collection times or collection triggers for a tag to obtain vehicle information. For example, an owner or manager of a fleet of vehicles could use application 408 to set multiple vehicles (as indicated by vehicle indicators, e.g., vehicle indicators 410, 418) to obtain or receive vehicle information at tags associated with the vehicles on a regular or rolling basis, or in response to a group command or group setting.

In an example, a manager or a set of rental cars can use application 408 to instruct each tag (associated with each rental car in the set) to collect vehicle mileage and driver or UE information, and/or registration or license information, on a daily basis or a weekly basis, or in response to a request or audit command across the set of vehicles. This can be implemented by UEs with applications when they are within range of any tag for the set of cars, or within range of a specific tag (in other words, any employee-driver with a UE could cause a tag in a fleet of vehicles to request vehicle information, or only an assigned employee-driver's UE may cause a corresponding tag in the fleet to request vehicle information).

Vehicle information (e.g., vehicle information 414) can comprise location information, maintenance history or needs, license plate expiration date or status, or other vehicle information (for example if a passenger is present according to an airbag system, or if a vehicle has been stationary or moving in the past day or two-hour time period, for instance). This information can assist a DMV with monitoring or enforcing registration or licensing requirements. Information can assist authorities such as police or other agencies in investigations, or be used by public or private entities for research or insurance-rate purposes. Entities such as authorities, or organizations with employee-used vehicles or vehicle rentals, can receive vehicle information, for example via application 408, in order to obtain up-to-date information while vehicles are on the road or not in a central location.

In some cases, an application may obtain vehicle information that is identification information, for use by a Division of Motor Vehicles (DMV) or other agency, in some cases in combination with data regarding whether a vehicle has an unexpired or expired registration or license. An employer can verify which employees (based on their UEs) are using which vehicles and an employer can obtain information about those vehicles, such as maintenance needs or mileage information (e.g., miles traveled in past 12 hours, etc.). An employer or other entity can determine when UEs are out of range of vehicles over a time period.

A government worker with an application such as application 308 or 408 can use a UE (e.g., UE 304) to obtain vehicle information 312 about a vehicle such as whether a permit or registration has expired or the amount of remaining time until expiration of a license. In some cases, a worker can apply tag 116 to vehicle 114 as part of a registration process, then a vehicle owner or driver can use application 308 in the future to submit registration information or location information to facilitate a renewal of registration. For instance, in the future an owner of vehicle 114 can use UE 104 in proximity to tag 116, which was provided by or approved by a government entity, to establish or renew a vehicle license or registration.

In other examples, a driver of vehicle 114 uses tag 116 to verify vehicle location or mileage for purposes of taxes, toll-type payments, or low-mileage credits. In some cases an authority may use application 408 to verify or view vehicle information 414 for multiple vehicles, or a driver or vehicle owner can use application 308 to submit specific or approved information to an authority in a secure or encrypted manner. A driver of a vehicle such as vehicle 114 can use an application 308 to establish a vehicle is in a certain parking location or driving lane, or moving at a certain speed or expected to arrive at a particular time, for example when a rental car is being returned or a driver has been hired.

As explained above, tag 116 is small and discreet, in embodiments, because it is passive or at least semi-passive. This allows tag 116 to be used with a variety of vehicles, such as cars, trucks, carts, scooters, electric bikes or other bikes, etc. For example, a company that provides scooters for rental can allow customers or other users with an application (e.g., application 308) to use their UE to submit information about scooters by using their UE to power tag 116 on vehicle 114, where vehicle 114 is a scooter associated with that company. This can be used by individuals with UEs interested in renting or using scooters or interested in charging or otherwise servicing vehicles such as scooters for reimbursement by a scooter-rental company. Such a system could also apply to electric bikes, non-electric bikes, skateboards, surfboards, kayaks, or other transportation equipment that can be rented or used by authorized users where the users control UEs with application(s) or otherwise able to power tag 116. In these examples, tag 116 can obtain and store information about recent users or the most-recent user based on the UE used to power tag 116.

FIG. 4 show third vehicle indicator 424 along with corresponding third vehicle information 426, which is displayed on interface 400. A user can navigate to third vehicle information 426, or to additional information such as real-time updates (e.g., movements), by interacting with selectable icon 428 on interface 400. Application 408 can include map 430 for displaying real-time (including near real-time) or most-recent location information of multiple vehicles, as shown by vehicle indicators 418 and 424 on map 430. Exemplary map 430 in FIG. 4 is illustrated with two vehicles indicators (e.g., vehicle indicators 418, 424) shown together and including selectable icons 422, 428 within map 430, but indicators and icons can be adjacent to map 430.

In embodiments, a user selects vehicle indicator 418 or selectable icon 428 in order to zoom in and/or to obtain UE information associated with the vehicle that corresponds to vehicle indicator 418, or to obtain more vehicle information, such as from a tag on the corresponding vehicle (e.g., prior UE vehicle-contact information, mileage, repair or recall-related information, speed, etc.). In other words, vehicle 418 and vehicle 424 as represented on map 430 are themselves selectable icons that can be touched by a user of interface 400 in order to request vehicle information 420 and/or vehicle information 426, which was obtained be tags on vehicles 418, 424, as described herein.

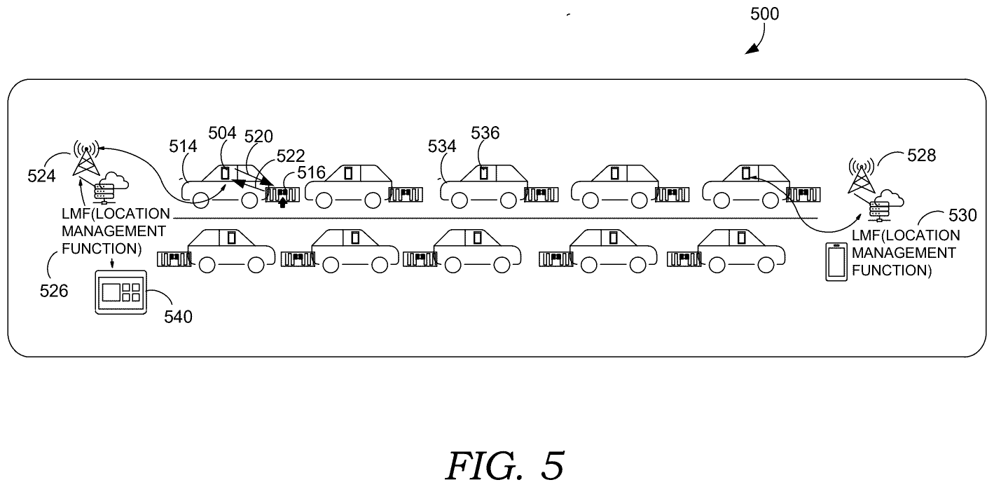

In FIG. 5, exemplary environment 500 shows a representation of vehicles each associated with UEs, including first UE 504 associated with first vehicle 514. FIG. 5 illustrates passive devices associated with vehicles, such as passive device 516. Arrow 520 points in the direction from UE 504 to passive device 516 and represents radio waves used for activating or powering up passive device 516. Arrow 522 points in the direction from passive device 516 to UE 504 and represents a reading of data from passive device 516 (e.g, a tag such as tag 116 in FIG. 1). The data can comprise an encrypted license plate number and an expiration date associated with vehicle 514 that is provided to UE 504 from passive device 516.

First cell site 524 can be a base station in communication with first LMF 526, which can receive information from UE 504 via a network, for example. As shown in FIG. 5, another cell site 528 is in communication with another LMF 530, which can also receive information from various UEs or from UE 504 as it moves closer to the other cell site 528 as it travels. The vehicle at 534 associated with UE 536 can represent vehicle 514 and UE 504 in another position, either earlier or later in time as vehicle 514 travels along a route. In other cases, vehicle 534 is a separate vehicle and two or more vehicles are associated with an entity and/or an application, such as application 408 in FIG. 4. In FIG. 5, entity 540 can indicate a DMV, a DOT, a car rental company, or other business or agency that receives vehicle information. For example, a DMV as entity 540 can use an application such as application 408 and verify the expiration status of one or more vehicles. A company managing a fleet of vehicles or employees as entity 540 can use application 408 to track a status and/or location or driver of one or more vehicles.

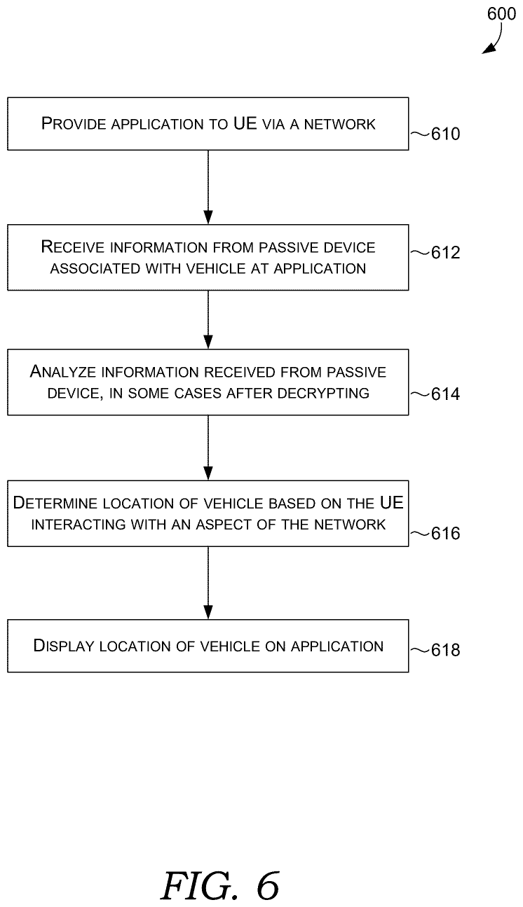

FIG. 6 illustrates a flow diagram 600 of aspects of embodiments. As shown at 610, an application (e.g., application 308) is provided to a UE, such as UE 104. At 612, the application receives information from a passive device associated with a vehicle. As shown at 614, the information received from the passive device, such as tag 116 in FIG. 1, is analyzed, and in some cases it is unencrypted prior to being analyzed. At 616, a location of the vehicle is determined based on UE 104 interacting with a component of network 106.

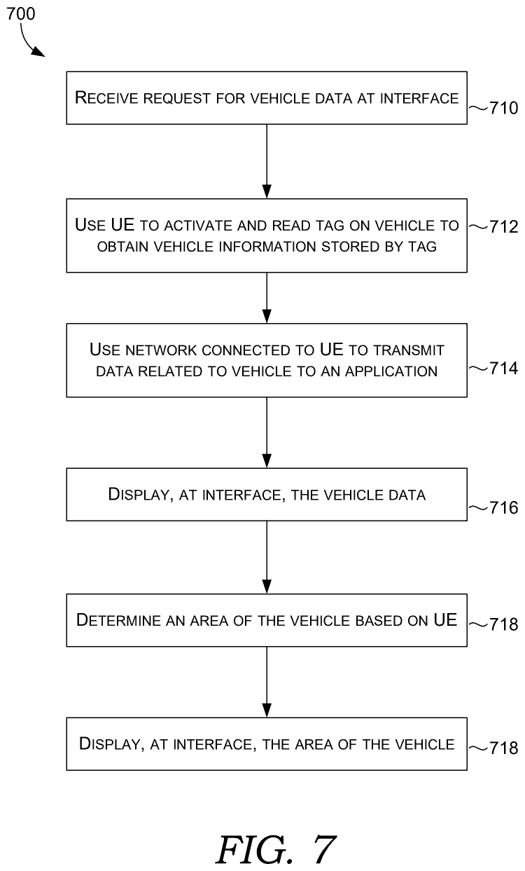

FIG. 7 shows a flow diagram 700 in accordance with an embodiment. As shown at 710. embodiments include receiving, at an interface, a request for data related to a vehicle, such as vehicle 114 in FIG. 1. At 712, embodiments include using a mobile device to activate and read a tag corresponding to the vehicle (e.g., by being attached or joined to a part of the vehicle), and the tag stores the requested data for the vehicle. As shown at 714, embodiments include using a network connected to the mobile device to transmit the data to an application, and, as shown at 716, embodiments further include displaying, at the interface, the data related to the first vehicle using the application. At 718, as shown in FIG. 7, a geographic area of the first vehicle is determined based on the mobile device, such as UE 104. At 720, embodiments include displaying, at the interface, the geographic area of the first vehicle.

Referring now to FIG. 8, a diagram is depicted of an exemplary computing environment suitable for use in implementations of the present disclosure. In particular, the exemplary computer environment is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 8, computing device 800 includes bus 802 that directly or indirectly couples the following devices: memory 804, one or more processors 806, one or more presentation components 808, input/output (I/O) ports 810, I/O components 812, power supply 814 and radio(s) 816. Bus 802 represents what may be one or more busses (such as an address bus, data bus, or combination thereof). Although the devices of FIG. 8 are shown with lines for the sake of clarity, in reality, delineating various components is not so clear, and metaphorically, the lines would more accurately be grey and fuzzy. For example, one may consider a presentation component, such as a display device to be one of I/O components 812. Also, processors, such as one or more processors 806, have memory. The present disclosure hereof recognizes that such is the nature of the art, and reiterates that FIG. 8 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 804 includes computer-storage media in the form of volatile and/or nonvolatile memory. Memory 804 may be removable, non-removable, or a combination thereof. Exemplary memory includes solid-state memory, hard drives, optical-disc drives, etc. Computing device 800 includes one or more processors 806 that read data from various entities, such as bus 802, memory 804, or I/O components 812. One or more presentation components 808 presents data indications to a person or other device. Exemplary one or more presentation components 808 include a display device, speaker, printing component, vibrating component, etc. I/O ports 810 allow computing device 800 to be logically coupled to other devices, including I/O components 812, some of which may be built in computing device 800. Illustrative I/O components 812 include a microphone, joystick, game pad, satellite dish, scanner, printer, wireless device, etc.

Radio 816 represents a radio that facilitates communication with a wireless telecommunications network. Illustrative wireless telecommunications technologies include CDMA, GPRS, TDMA, GSM, and the like. Radio 816 might additionally or alternatively facilitate other types of wireless communications including Wi-Fi, WiMAX, LTE, or other VoIP communications. As can be appreciated, in various embodiments, radio 816 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A system for viewing vehicle information, the system comprising:
one or more processors; and
one or more computer-readable media storing computer-usable instructions that, when executed by the one or more processors, cause the one or more processors to:
provide an application to a user device, wherein the application receives information from a passive device that corresponds to a vehicle;
analyze the information received from the passive device;
determine a location area of the vehicle based on the user device interacting with a network component.

2. The system of claim 1, wherein the application receives information from the passive device based on the application causing the user device to emit radio waves.

3. The system of claim 2, wherein the radio waves comprise radio waves that operate in a WiFi, Bluetooth, or cellular frequency.

4. The system of claim 3, wherein the passive device uses a back-scattered radio signal to send the information from the passive device to the user device.

5. The system of claim 1, wherein determining the location area is based at least in part on a downlink/uplink angle of arrival associated with the user device.

6. The system of claim 1, wherein determining the location area is based at least in part on a downlink/uplink time difference of arrival.

7. The system of claim 1, wherein the information received from the passive device comprises maintenance-related information.

8. A method for providing data related to a vehicle for viewing, the method comprising:
receiving, at an interface of a first mobile device, a request for data related to a first vehicle;
issuing the request to a second mobile device, wherein the request causes the second mobile device to activate and read a first tag affixed to the first vehicle, wherein the first tag stores the data related to the first vehicle;
receiving the data related to the first vehicle, from the second mobile device, at an application associated with the interface of the first mobile device; and
displaying, at the interface of the first mobile device, the data related to the first vehicle.

9. The method of claim 8, wherein the data related to the first vehicle comprises an indication of an expiration status.

10. The method of claim 9, wherein the data related to the first vehicle further comprises a license plate number of the first vehicle.

11. The method of claim 8, wherein using the second mobile device to activate the first tag and receive the data related to the first vehicle from the first tag using a back-scattered radio signal.

12. The method of claim 8, further comprising:
determining a geographic area of the first vehicle based on the second mobile device; and
displaying, at the interface of the first mobile device, the geographic area of the first vehicle.

13. The method of claim 12, wherein determining the geographic area of the first vehicle based on the second mobile device comprises using one or more components of the network to determine first location information for the second mobile device.

14. The method of claim 13, wherein using one or more components of the network to determine the first location information for the second mobile device comprises determining Enhanced Cell ID positioning for the mobile device.

15. A non-transitory computer readable media having instructions stored thereon that, when executed by one or more computer processing components, cause the one or more computer processing components to perform a method for facilitating viewing of vehicle information, the method comprising:
causing a mobile device to receive vehicle information for a first vehicle from a passive device;
receiving information associated with the mobile device;
using the information associated with the mobile device to determine a geographic area;
associating the geographic area with the first vehicle; and
providing the vehicle information and the geographic area to an application for viewing.

16. The non-transitory computer readable media of claim 15, wherein the passive device is connected to a vehicle information output of the first vehicle.

17. The non-transitory computer readable media of claim 15, wherein the passive device is in communication with an on-board diagnostics port.

18. The non-transitory computer readable media of claim 15, wherein the passive device communicates with the mobile device using, at least in part, a back-scattered signal.

19. The non-transitory computer readable media of claim 15, wherein the application provides a notification regarding the geographic area.

20. The non-transitory computer readable media of claim 15, wherein the vehicle information comprises identification information for the vehicle.
